(19) United States
(12) Patent Application Publication
(10) Pub. No.: US 2007/0081435 A1
(43) Pub. Date: Apr. 12, 2007

(54) Optical disc apparatus

(75) Inventor: Tatsuya Ishitobi, Kawasaki (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignees: Hitachi, Ltd., Tokyo (JP); Hitachi-LG Data Storage, Inc., Tokyo (JP)

(21) Appl. No.: 11/490,739

(22) Filed: Jul. 21, 2006

(30) Foreign Application Priority Data
Oct. 12, 2005 (JP) 2005-297076

(51) Int. Cl. G11B 7/12

(52) U.S. Cl. 369/47.52

(57) ABSTRACT

Some conventional optical disc apparatuses must continuously perform a recording operation if they continuously receive data from the host apparatus, which eliminates the opportunity for them to perform necessary internal adjustments during the recording operation. Other conventional optical disc apparatuses can perform internal adjustments even if they continuously receive data from the host apparatus. However, they may need to use an inappropriate disc area to make such adjustments. The present invention has been devised to solve these problems. The present invention provides a method for recording data on a disc which allows an optical disc apparatus to perform necessary internal adjustments during a recording operation even if it continuously receives data from the host apparatus during that operation. Further, the present invention also provides an adjustment method that allows an optical disc apparatus to perform adjustments using an appropriate area on the disc.

### CLAIM OF PRIORITY

The present application claims priority from Japanese application serial No. P2005-297076, filed on Oct. 12, 2005, the content of which is hereby incorporated by reference into this application.

### BACKGROUND OF THE INVENTION

1. Field of the Invention

The present invention relates to a technique for improving the performance of an optical disc apparatus.

2. Description of the Related Art

An optical disc apparatus may be adapted to perform necessary internal adjustments during the period when it is not performing a recording operation. Such an optical disc apparatus is disclosed in Japanese Patent Laid-Open No. 2000-182245. Specifically, this publication describes an optical disc reproduction/recording apparatus capable of recording information on a disc under suitable conditions even if the recording characteristics of the disc surface vary with position due to temperature variations.

### SUMMARY OF THE INVENTION

Some conventional optical disc apparatuses must continuously perform a recording operation if they continuously receive data from the host apparatus, which eliminates the opportunity for them to perform necessary internal adjustments during the recording operation. Other conventional optical disc apparatuses can perform internal adjustments even if they continuously receive data from the host apparatus. However, they may need to use an inappropriate disc area to make such adjustments. The present invention has been devised to solve these problems.

It is, therefore, an object of the present invention to provide a recording apparatus capable of performing necessary internal adjustments during a recording operation even if it continuously receives data from the host apparatus during that operation. Another object of the present invention is to provide an adjustment apparatus capable of performing adjustments using an appropriate area on a disc.

That is, the present invention allows an optical disc apparatus to perform adjustments to ensure proper reproduction and recording operations, thereby enhancing reproduction and recording quality.

### BRIEF DESCRIPTION OF THE DRAWINGS

FIG. 1 is a diagram showing a host apparatus and an optical disc apparatus according to the present invention;

FIG. 2 is a diagram showing recording operation performed by the optical disc apparatus of the present invention;

FIG. 3 is diagram illustrating the principle of the recording operation performed by the optical disc apparatus of the present invention;

FIG. 4 shows exemplary address information sent from the host apparatus to the optical disc apparatus according to the present invention; and

FIG. 5 is a diagram illustrating the effect of the present invention.

### DESCRIPTION OF THE PREFERRED EMBODIMENTS

An embodiment of the present invention will now be described.

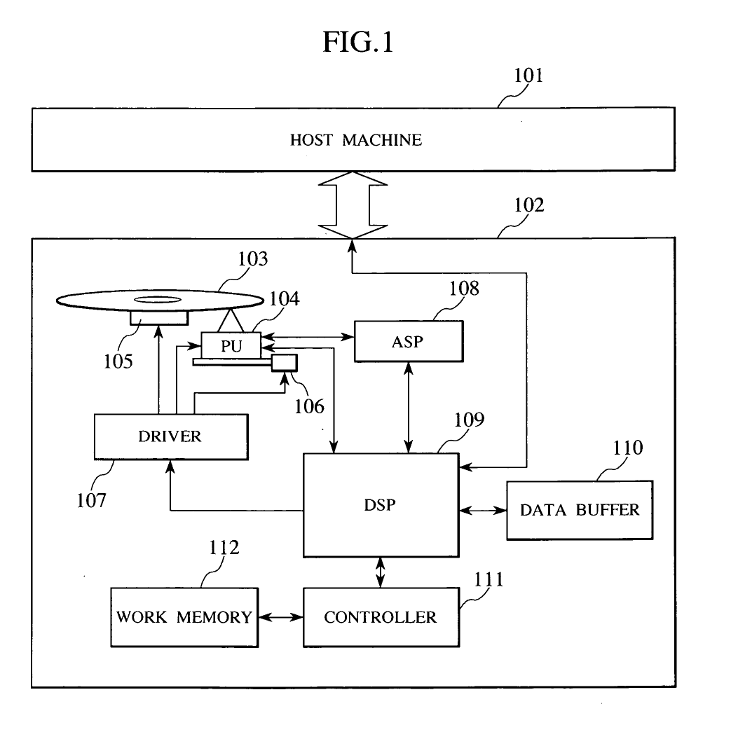

The present invention allows an optical disc apparatus to perform necessary internal adjustments using an appropriate area on a disc. First, how this is done will be described with reference to FIG. 1.

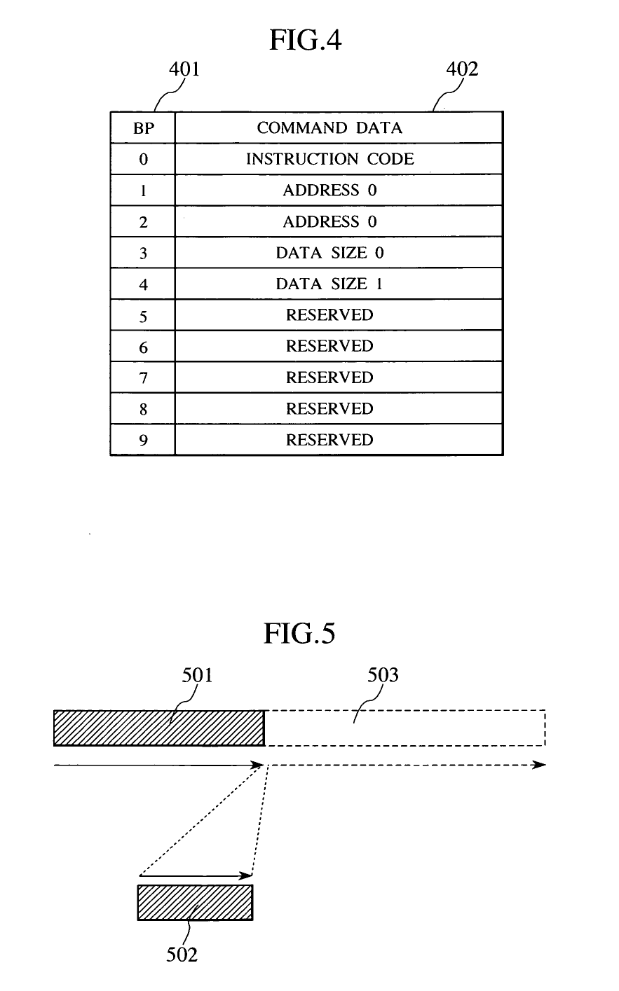

In FIG. 1, reference numeral 102 denotes an optical disc apparatus, and reference numeral 101 denotes a host apparatus for the optical disc apparatus 102. As used herein, the term “host apparatus” refers to, for example, a personal computer, the back-end portion of a video recorder, etc. having the optical disc apparatus 102 therein. The optical disc apparatus 102 operates in response to a command issued by the host apparatus 101 and records data on or reproduces data from the disc. The command or information sent from the host apparatus 101 to the optical disc apparatus 102 has a data structure as shown in FIG. 4, for example.

FIG. 4 shows an exemplary command made up of 10 bytes of data. In FIG. 4, the left column denoted by reference numeral 401 indicates each byte position (BP), and the right column denoted by reference numeral 402 indicates the type of data stored in each byte position. The first byte or field stores an instruction code indicating the type of command, the second and third bytes or fields each stores an address, and the fourth and fifth bytes or fields each stores a data size. Further, the subsequent 5 bytes or fields are reserved for future expansion and referred to as “reserved bytes”. For example, to instruct the optical disc apparatus 102 to perform a recording operation, the host apparatus 101 sends to the optical disc apparatus 102 a command in which: the Instruction Code field stores an instruction code indicating a recording operation; the Address field stores a recording start address; and the Data Size field stores the size of data to be sent to the optical disc apparatus 102.

Upon receiving this command, the optical disc apparatus 102 reproduces the fields of the command and subsequently performs a recording operation on the disc as specified by the command, that is, the optical disc apparatus 102 records data of the specified size to addresses starting with the specified recording start address.

On the other hand, to instruct the optical disc apparatus 102 to perform a reproduction operation, the host apparatus 101 sends to the optical disc apparatus 102 a command in which: the Instruction Code field stores an instruction code indicating a reproduction operation; the Address field stores a reproduction start address; and the Data Size field stores the size of data to be reproduced. Upon receiving this command, the optical disc apparatus 102 performs a reproduction operation on the disc as specified by the command. Further, the host apparatus 101 and optical disc apparatus 102 may also be adapted such that the host apparatus 101 can instruct the optical disc apparatus 102 to perform other operations using commands.

Thus, the optical disc apparatus 102 receives commands specifying various operations from the host apparatus 101. However, to reliably perform these specified operations, the optical disc apparatus 102 must make various types of adjustments, which may require some adjustment values to be changed. For example, to reliably perform a recording operation, the optical disc apparatus must adjust the power of the laser delivered to the disc to an appropriate value. Since the laser characteristics vary with temperature, they must be checked and adjusted so as to be able to properly perform a recording or reproduction operation. Further, the sensitivity of the optical disc surface to a laser beam may vary with position, requiring the laser power to be adjusted to accommodate these sensitivity variations.

One method for controlling laser power is to reproduce a recorded area on the disc and adjust the laser power based on the magnitude, etc. of jitter observed during this reproduction operation. The magnitude of jitter can be used as a recording quality indicator. This method is known to be effective but is disadvantageous in that if data is recorded on areas as shown in FIG. 5, the method cannot provide accurate laser power adjustment. Specifically, in FIG. 5, data is first recorded on an area 501 of the disc and then recorded on an area 502 located away from the area 501. After that, data is recorded on an area 503 contiguous with the area 501. When the optical disc apparatus 102 records data on these areas in the manner described above using the above conventional laser power adjustment method, the following problem arises.

First, the optical disc apparatus 102 records data on the area 501 according to a command received from the host apparatus 101. Then, to prepare for the next recording operation, the optical disc apparatus 102 reproduces the area 501 and adjusts the laser power according to the results of the reproduction operation. Subsequently, when the optical disc apparatus 102 has received from the host apparatus 101 a command requesting a recording operation on the area 502, the optical disc apparatus 102 does so with the above adjusted laser power adjusted according to the results of the reproduction operation on the area 501. Then, to prepare for the subsequent recording operation, the optical disc apparatus 102 reproduces the area 502 and adjusts the laser power according to the results of the reproduction operation. Subsequently, when the optical disc apparatus 102 has received from the host apparatus 101 a command requesting a recording operation on the area 503, the optical disc apparatus 102 does so with the above adjusted laser power adjusted according to the results of the reproduction operation on the area 502.

This method has a problem in that a recording operation on an area may be performed with laser power adjusted according to the results of a reproduction operation on an area located away from it. As described above, the sensitivity of the optical disc surface to a laser beam varies with position. Therefore, a recording operation on an area must be performed with laser power adjusted according to the results of a reproduction operation on an area adjacent it. In the example shown in FIG. 5, the optical disc apparatus 102 must perform a recording operation on the area 503 with laser power adjusted according to the results of a reproduction operation on the area 501, instead of the area 502.

However, the optical disc apparatus 102 cannot predict that the host apparatus 101 will instruct it to record on the area 503 after recording on the area 502. Therefore, all that the optical disc apparatus 102 can do is to record on the area 503 with laser power adjusted according to the results of a reproduction operation on the area 502 located away from the area 503, that is, with improperly adjusted laser power, resulting in failure to perform the recording operation with accuracy.

According to the present invention, to circumvent the above problem, the host apparatus 101 sends to the optical disc apparatus 102 a command including information about an area on the disc to be used for adjustment, that is, an area of the disc on which a reproduction operation is to be performed to adjust laser power. Receiving this information or command, the optical disc apparatus 102 makes adjustments by performing a reproduction operation on this area. The host apparatus 101 determines to which areas data is to be recorded and in what order, and manages such information. Therefore, if the host apparatus 101 can send to the optical disc apparatus 102 a command specifying these areas and the order in which data is to be recorded on them, the optical disc apparatus 102 can properly adjust the laser power and hence properly perform recording operation.

The host apparatus 101 sends the above command of the present invention to the optical disc apparatus 102 immediately after sending a recording command. This allows the optical disc apparatus 102 to easily determine the next area of the disc on which to record. Further, the above command of the present invention may be a 10 byte command as shown in FIG. 4. In this case, the Instruction Code field may store a code indicating that this command specifies a disc area to be used for adjustment; the Address field may store the start address of the area; and the Data Size field may store the size of the area.

It should be noted that the types of adjustments that the optical disc apparatus 102 can perform using the command of the present invention are not limited to laser power adjustment. The present invention can be applied to adjustment of any characteristic that may vary with position on the disc. Further, although the present invention has been described with reference to an example in which the host apparatus 101 sends the command of the present invention to the optical disc apparatus 102 immediately after sending a recording command, the invention is not limited to this particular arrangement. For example, the command of the present invention may be sent immediately after sending a reproduction command and may be used to perform adjustments for a reproduction operation. Further, the command of the present invention may not be a separate command. Specifically, the above information about a disc area to be used for adjustment may be included in a recording or reproduction command using reserved bytes shown in FIG. 4. That is, the command of the present invention and a recording or reproduction command may be combined together into a single command. Further, the data size and data structure of the command of the present invention are not limited to those shown in FIG. 4.

The following first describes the configuration of the optical disc apparatus 102 shown in FIG. 1. Then, a method and apparatus of the present invention are described. As described above, a conventional optical disc apparatus 102 must continuously perform a recording operation if it continuously receives data from the host apparatus 101, which eliminates the opportunity for the optical disc apparatus to perform necessary internal adjustments during the recording operation. The present invention has been devised to solve this problem.

In FIG. 1, reference numeral 103 denotes an optical disc mounted in the optical disc apparatus 102; 104, an optical pickup (PU) for recording data on the disc and receiving the reflected light from the disc; 105, a spindle motor for rotating the optical disc 103; 106, a threading motor for moving the pickup 104 in a radial direction; 107, a motor driver for driving the lens actuator within the pickup 104, the spindle motor 105, and the threading motor 106; and 108, an analog signal processor (ASP) for processing the analog signal from the optical pickup 104 and generating reproduction and servo signals.

Reference numeral 109 denotes a controller. In this example, the controller 109 is a control circuit, or a digital signal processor (DSP), for performing the major functions of the optical disc apparatus 102, that is, such functions as exchanging data with the host apparatus 101, decoding a reproduction signal, modulating a recording signal, and performing servo control. Still referring to FIG. 1, reference numeral 110 denotes a data buffer for storing data to be recorded on or reproduced from the optical disc under the control of the digital signal processor 109; reference 111 denotes a system controller for controlling the entire optical disc apparatus 102; and reference numeral 112 denotes working memory for storing processing data for the system controller 111.

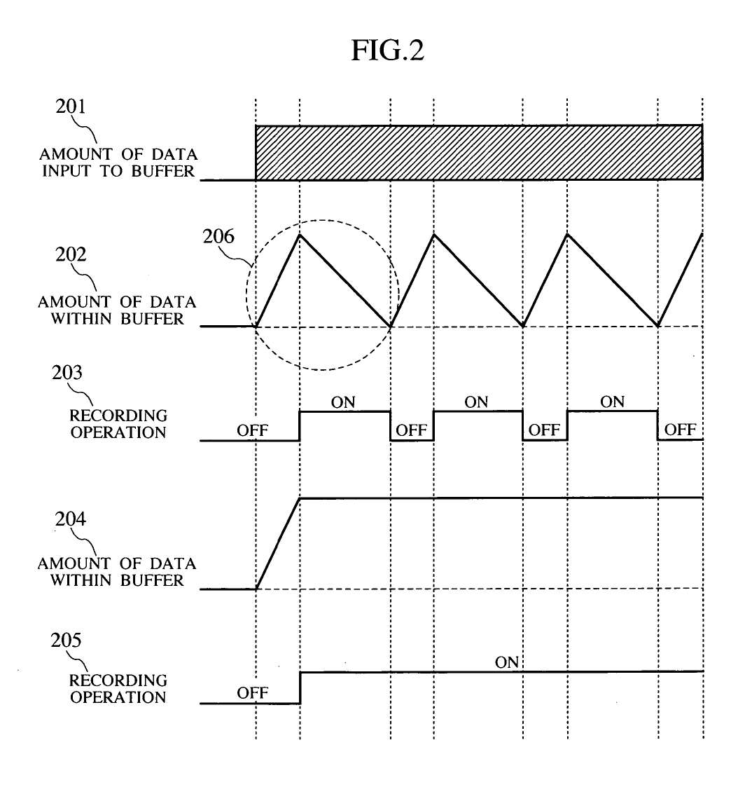

If the optical disc apparatus 102 shown in FIG. 1 continuously receives data from the host apparatus 101, the optical disc apparatus 102 performs a recording operation as shown in FIG. 2. Specifically, in FIG. 2, reference numeral 201 denotes a chart representing the data input to the data buffer of the optical disc apparatus 102, indicating that data is continuously delivered from the host apparatus 101 to the optical disc apparatus 102. Reference numeral 202 denotes a chart representing the amount of data within the data buffer, which varies with time. The vertical axis represents increasing amount of data accumulated within the buffer from bottom to top. Reference numeral 203 denotes a chart indicating how the optical disc apparatus 102 performs recording operation, wherein “OFF” indicates a period during which a recording operation is not performed and “ON” indicates a period during which a recording operation is performed.

As shown in FIG. 2, if the optical disc apparatus 102 retrieves data from the data buffer and records it on the disc at a higher rate than the data buffer receives data, the recording operation of the optical disc apparatus 102 is intermittent even if data is continuously delivered to the data buffer during that operation. This allows the optical disc apparatus 102 to perform various adjustments during the periods when it is not performing a recording operation.

To achieve such an intermittent recording operation, the data output rate from the data buffer must be higher than the data input rate. When the data input rate to the data buffer is equal to the maximum data transfer rate to the optical disc, however, the data buffer is always filled with data, as indicated by a chart 204 in FIG. 2. As a result, the recording operation of the optical disc apparatus 102 is a continuous operation as indicated by a chart 205 in FIG. 2, not an intermittent operation, which prevents the optical disc apparatus 102 from performing various necessary internal adjustments during the recording operation or its interruption periods.

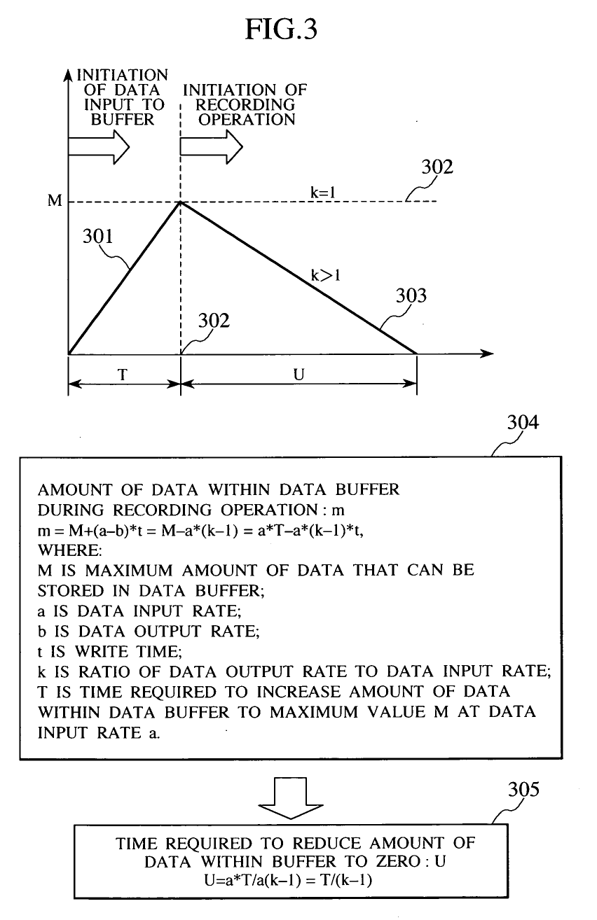

The present invention provides an apparatus adapted to record data on a disc without causing the above problem, as described below with reference to FIG. 3.

The graph shown in FIG. 3 is an enlarged view of the chart portion indicated by broken circle 206 in FIG. 2. The horizontal axis represents time and the vertical axis represents the amount of data within the data buffer. Reference numeral 301 denotes a line indicating how the amount of data within the data buffer varies with time when data is delivered to the data buffer at rate a. The amount of data within the data buffer reaches its maximum value M, T seconds after initiation of the delivery. Reference numerals 302 and 303 each denotes a line indicating how the amount of data within the data buffer varies with time when the optical disc apparatus 102 records data on the disc at rate b while data is still being delivered to the data buffer at rate a after the amount of data within the data buffer reached its maximum value M.

In the case of the line 302, the data output rate b of the data buffer is equal to the data input rate a. That is, the ratio k of the data output rate b to the data input rate a is 1. In the case of the line 303, the ratio k is lower than 1. The ratio k is 1 when the host apparatus 101 delivers data to the optical disc apparatus 102 at a rate equal to the maximum data transfer rate to the optical disc.

In this case, even if the optical disc apparatus 102 records data on the disc, the amount of data accumulated within the data buffer does not decrease and hence the recording operation of the optical disc apparatus 102 is not an intermittent operation. That is, the optical disc apparatus 102 must continuously perform the recording operation until the host apparatus 101 stops delivering data, which eliminates the opportunity for the optical disc apparatus 102 to perform various adjustments during the recording operation.

However, if the ratio k (b/a) of the data output rate b of the data buffer to the data input rate a is higher than 1, the data accumulated within the data buffer can be completely depleted in a finite time denoted by U in FIG. 3. See equations 304 and 305 in FIG. 3 for better understanding of the principle. Equation 304 shown in FIG. 3 represents the amount of data within the data buffer a time t after initiation of the recording operation.

Equation 305 in FIG. 3 represents the time U required to completely deplete the data buffer of data. This equation indicates that if the data output rate exceeds the data input rate even slightly, the data within the data buffer can be completely depleted in a finite time U.

Based on this fact, the present invention allows the optical disc apparatus 102 to intermittently perform a recording operation even when the data input rate to the data buffer is equal to a predetermined maximum data transfer rate to the optical disc, as described below.

For example, assume that the data input rate from the host apparatus 101 to the optical disc apparatus 102 is 100 and equal to the maximum data transfer rate to the optical disc. In this case, if the optical disc apparatus 101 records data on the disc at a rate slightly higher than the maximum data transfer rate to the disc (i.e., 100), for example, at a rate of 100.5 (a 0.5% higher rate), the data buffer becomes empty a time of 200*T later and then the optical disc apparatus 102 need not perform a recording operation for a time of T, as indicated by equation 305 in FIG. 3.

This means that for each time period of 200*T, there is a time period of T during which no recording operation need be performed, resulting in an intermittent recording operation. For example, when the time period T is one second, the optical disc apparatus 102 need not perform a recording operation for one second once every 200 seconds and hence can perform various necessary internal adjustments instead.

Thus, according to the present invention, the host apparatus delivers data to the data buffer at a rate equal to or lower than a predetermined maximum data transfer rate to the optical disc, whereas the optical disc apparatus records data on the optical disc at a rate higher than the predetermined maximum data transfer rate to the optical disc. With this arrangement, the data output rate from the data buffer is higher than the data input rate during the recording operation, providing time for the optical disc apparatus to perform various necessary adjustments.

It should be noted although according to the present invention the optical disc apparatus records data on the disc at a rate slightly higher than the maximum data transfer rate to the disc, no problem should usually arise, since optical disc apparatuses are usually built to have safety margins. In practical applications, it may be necessary to check how much the maximum data transfer rate can be exceeded.

Thus, the optical disc apparatus of the present invention can perform necessary internal adjustments during a recording operation even if it continuously receives data from the host apparatus during that operation. Further, the present invention allows the optical disc apparatus to perform adjustments using an appropriate area on the disc.

What is claimed is:

1. An optical disc apparatus performing internal adjustments, said optical disc apparatus comprising a controller performing the steps of:
exchanging data with a host apparatus;
performing an adjustment for a data recording operation or a data reproduction operation based on information sent from said host apparatus to said optical disc apparatus, said information at least including positional information on an area on a disc, said positional information being used for said adjustment; and
performing said adjustment for said data recording operation or said data reproduction operation based on said positional information.

2. The optical disc apparatus as claimed in claim 1, wherein said adjustment for said data recording operation or data reproduction operation is adjustment of power of a laser delivered to said optical disc, said adjustment being performed based on said positional information included in said information sent from said host apparatus to said optical disc apparatus.

3. The optical disc apparatus as claimed in claim 1, wherein said positional information for said adjustment is address information, said positional information being included in said information sent from said host apparatus to said optical disc apparatus.

4. An optical disc apparatus performing internal adjustments, said optical disc apparatus comprising:
a data buffer for temporarily storing data delivered from a host apparatus to said optical disc apparatus; and
a controller;
wherein said controller records data at a rate higher than a predetermined maximum data transfer rate to an optical disc; and
wherein the data output rate from said data buffer is always higher than the data input rate to said data buffer during said data recording operation.

5. The optical disc apparatus as claimed in claim 4, wherein an adjustment for a data recording operation or a data reproduction operation is performed during a period when a data recording operation is not being performed on said optical disc, said period occurring due to the difference between said data output rate from said data buffer and said data input rate to said data buffer.

6. An optical disc apparatus performing internal adjustments, said optical disc apparatus comprising:
a data buffer for temporarily storing data delivered from a host apparatus to said optical disc apparatus; and
a controller;
wherein said host apparatus delivers said data to said data buffer at a rate equal to or lower than a predetermined maximum data transfer rate to said optical disc;
wherein said controller records data on an optical disc at a rate higher than a predetermined maximum data transfer rate to said optical disc; and
wherein the data output rate from said data buffer is higher than the data input rate to said data buffer during said data recording operation.
